(19) United States
(12) Patent Application Publication
(10) Pub. No.: US 2005/0262152 A1
(43) Pub. Date: Nov. 24, 2005

(54) Information transferring method and apparatus

(75) Inventors: Michihiro Ota, Tokyo Saitama (JP); Hiroaki Yoshida, Saitama (JP); Setsufumi Kamuro, Tokyo (JP)

Correspondence Address: WELSH & KATZ, LTD, 120 S RIVERSIDE PLAZA, 22ND FLOOR, CHICAGO, IL, 60606, US

(73) Assignee: Kabushiki Kaisha Nippon Conlux, Tokyo (JP)

(21) Appl. No.: 10/523,129

(22) PCT Filed: Jul. 28, 2003
(86) PCT No.: PCT/JP03/09508

§ 371 Date: Jan. 21, 2005

(30) Foreign Application Priority Data
Jul. 31, 2002 (JP) 2002-223553

(51) Int. Cl. G06F 12/00

(52) U.S. Cl. 707/200

(57) ABSTRACT

When the user connects an information transferring device (2) to a predetermined external connection section of an offline device (1), the offline device (1) transmits information to the information transferring device (2), which stores the received information. Next, when the user removes the information transferring device (2), which has stored the information, from the offline device (1), and then the user connects the information transferring device (2) to a predetermined external connection section of a user's communication terminal (3), the information transferring device (2) controls the communication terminal (3) to commence communication between the communication terminal (3) and a center device (4), and then the communication terminal (3) transmits the information stored in the information transferring device (2) to the center device (4).

### TECHNICAL FIELD

The present invention relates to an information transferring method and device, and more particularly to an information transferring method and device which exchange information by the information transferring device detachably connectable to each of an offline device and a communication terminal.

### BACKGROUND ART

Generally, when internal information is transferred from a personal computer or the like disposed offline to another personal computer or the like, various types of external connection devices represented by a semiconductor memory device such as a flash memory, which is detachable from the personal computer and can write and read information signals, are used. Those external connection devices can record information such as still images, moving images, music and the like.

And, when a communication terminal is connected to the external connection device, information recorded on the external connection device can be read easily, and information exceeding an inside allowable storage amount of the personal computer can be stored conveniently.

Besides, with the widespread of networks such as Internet, for a personal computer or the like which can be set online, business models desiring to immediately transmit information obtained from a network such as Internet to a center device or the like which is connected to the network are increasing.

Incidentally, the above-described conventional external connection device has a function as a memory device only and, for example, when information recorded in the external connection device is transmitted to a center device through a communication terminal such as a cellular phone or the like, a series of operations to connect the external connection device to the communication terminal, to read information stored in the external connection device by the communication terminal and to transmit the read information to the center device must be performed by manually inputting by the user.

Therefore, if complex operations are required, there is a possibility of erroneous input, and information might not be transmitted accurately to the center device.

### DISCLOSURE OF THE INVENTION

Accordingly, the present invention provides an information transferring method and device which can transfer information possessed by an offline device to a center device by a simple operation without fail or can transfer information from the center device to the offline device by a simple operation without fail.

To achieve the above object, the invention of claim 1 is an information transferring method for transferring information possessed by an offline device to a center device by an information transferring device which is detachably connectable to the offline device and a communication terminal, comprising: connecting the information transferring device to the offline device to store the information into an internal memory of the information transferring device; after storing the information, connecting the information transferring device to the communication terminal; and controlling the communication terminal by the information transferring device in a state connected to the communication terminal to automatically transfer the information stored in the internal memory of the information transferring device to the center device.

The invention of claim 2 is directed to the invention of claim 1, wherein the information transferring device: stores operational procedure information for transfer of the information to the center device by the communication terminal; and controls the communication terminal according to the stored operational procedure information to control automatic transfer of the information stored in the internal memory of the information transferring device to the center device.

The invention of claim 3 is directed to the invention of claim 1, wherein the information transferring device: stores actively the information into the internal memory of the information transferring device when connected to the offline device; and automatically transfers the information to the center device by actively controlling the communication terminal when connected to the communication terminal.

The invention of claim 4 is directed to an information transferring method for transferring information possessed by a center device to an offline device by an information transferring device which is detachably connectable to the offline device and a communication terminal, comprising: connecting the information transferring device to the communication terminal; controlling the communication terminal by the information transferring device in a state connected to the communication terminal to automatically obtain the information possessed by the center device; storing the automatically obtained information into an internal memory of the information transferring device; after storing the information, connecting the information transferring device to the offline device; and transferring the information stored in the internal memory of the information transferring device to the offline device by the information transferring device.

The invention of claim 5 is directed to the invention of claim 4, wherein the information transferring device: stores operational procedure information for obtaining information from the center device by the communication terminal; and controls the communication terminal according to the stored operational procedure information to control the automatic acquisition of the information from the center device.

The invention of claim 6 is directed to the invention of claim 4, wherein the information transferring device: actively controls the communication terminal when connected to the communication terminal to automatically obtain the information from the center device and stores the automatically obtained information into the internal memory of the information transferring device; and actively transfers the information stored in the internal memory of the information transferring device to the offline device when connected to the offline device.

The invention of claim 7 is directed to an information transferring device which is configured to be detachably connectable to an offline device and a communication terminal and exchanges information via the communication terminal, comprising: an internal memory for storing information possessed by the offline device when connected to the offline device; and automatic communication control means for automatic transfer of the information stored in the internal memory to the center device by controlling the communication terminal when connected to the communication terminal.

The invention of claim 8 is directed to the invention of claim 7, wherein the automatic communication control means: controls the communication terminal when connected to the communication terminal to automatically obtain the information possessed by the center device; stores the automatically obtained information into the internal memory of the information transferring device; and transfers the information obtained by the automatic communication control means to the offline device when the information transferring device and the offline device are connected.

The invention of claim 9 is directed to the invention of claim 8 wherein the automatic communication control means comprises:
storage means for storing first operational procedure information for transferring information to the center device by the communication terminal and second operational procedure information for obtaining information from the center device by the communication terminal; first control means for controlling the automatic transfer of the information stored in the internal memory of the information transferring device to the center device by controlling the communication terminal according to the first operational procedure information stored in the storage means; and second control means for controlling the automatic acquisition of the information possessed by the center device by controlling the communication terminal according to the second operational procedure information stored in the storage means.

The invention of claim 10 is directed to the invention of claim 7, further comprising communication history erase instruction transmission means for transmitting an instruction of erasing a communication history of the automatic transfer and the automatic acquisition by the automatic communication control means to the communication terminal.

The invention of claim 11 is directed to the invention of claim 7, further comprising display means for displaying a communication state of the automatic transfer or the automatic acquisition by the automatic communication control means.

### BRIEF DESCRIPTION OF THE DRAWINGS

FIG. 1 is a block view showing an example of the outline structure of the information transfer system according to the information transferring method and device of the present invention;

FIG. 2 is a block view showing an example of the outline structure of an offline device 1 and an information transferring device 2;

FIG. 3 is a block view showing an example of the outline structure of the information transferring device 2 and a communication terminal 3;

FIG. 4 is a flow chart showing a processing procedure of transferring information from the offline device 1 to a center device 4 of the information transfer system according to the present invention;

FIG. 5 is a view showing a state that the information transferring device 2 is connected to a cellular phone 23 or the like as a communication terminal 3; and

FIG. 6 is a view showing a state that the information transferring device 2 is connected to a PDA 24 or the like as the communication terminal 3.

### BEST MODE FOR CARRYING OUT THE INVENTION

Embodiments of the information transferring method and device according to the present invention will be described in detail with reference to the accompanying drawings.

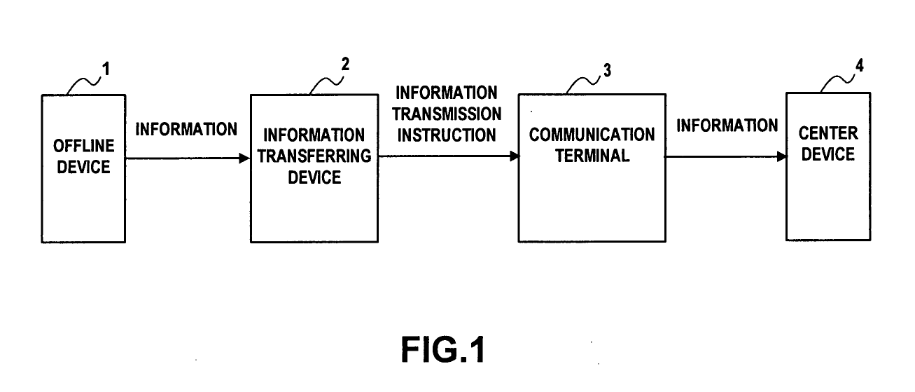

FIG. 1 is a block view showing an example of the outline structure of the information transfer system of the information transferring method and device according to the present invention.

As shown in FIG. 1, the information transfer system according to the information transferring method and device of the present invention is comprised of an offline device 1, an information transferring device 2, a communication terminal 3 and a center device 4.

Here, the offline device 1 is equipment not connected to a network or the like and includes, for example, AV equipment such as a camera or stereo components, home electric appliances such as refrigerators or washing machines, outdoor equipment such as automatic vending machines, and automobiles.

The center device 4 is a terminal for managing the offline device 1 and, for example, it is a terminal for storing images or motion pictures when the offline device 1 is AV equipment, a terminal of a customer service center when the offline device 1 is a home electric appliance, and a terminal for managing sales when the offline device 1 is outdoor equipment.

When the user connects the information transferring device 2 to a predetermined external connection section (not shown) of the offline device 1, the offline device 1 transmits information to the information transferring device 2, and the information transferring device 2 stores the received information.

The above description covers an example structure that the offline device 1 and the information transferring device 2 are physically connected to exchange information, but radio communications using infrared rays or the like may be employed for sending and receiving information. Thus, means for sending and receiving information is not limited to a particular one.

Then, the user removes the information transferring device 2 having stored the information from the offline device 1 and connects the information transferring device 2 to a predetermined external connection section (not shown) of the communication terminal 3 possessed by the user. Then, the information transferring device 2 controls the communication terminal 3 to initiate communication between the communication terminal 3 and the center device 4. And the communication terminal 3 transmits the information stored in the information transferring device 2 to the center device 4.

In the above description, the information transferring device 2 and the communication terminal 3 are physically connected to send and receive the information as an example structure, but radio communications using infrared rays or the like may be employed for sending and receiving information. Thus, means for sending and receiving information is not limited to a particular one.

The structure described below is also applicable. When the user connects the information transferring device 2 to a predetermined external connection section of the communication terminal 3, the information transferring device 2 controls the communication terminal 3 to initiate communication between the communication terminal 3 and the center device 4. Information is transmitted from the center device 4 to the communication terminal 3, and the information transferring device 2 stores the information received by the communication terminal 3. And, the user removes the information transferring device 2 having stored the information from the communication terminal 3 and connects the information transferring device 2 to a predetermined external connection section of the offline device 1. Then, the information is automatically transferred from the information transferring device 2 to the offline device 1.

Then, the operation performed when the offline device 1 and the information transferring device 2 are connected will be described.

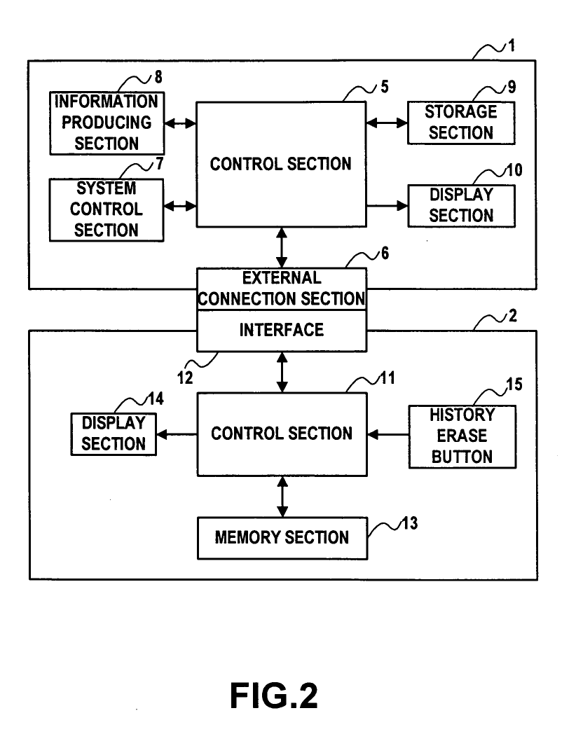

FIG. 2 is a block view showing an example of the outline structure of the offline device 1 and the information transferring device 2.

Here, the offline device 1 comprises a control section 5 which is a CPU (Central Processing Unit) for supervising the control of the entire offline device 1, an external connection section 6 for connection with the interface of the information transferring device 2, a system control section 7 which is a ROM (Read Only Memory) in which a control program for controlling the entire offline device 1 is stored, an information producing section 8 which produces information (e.g., information about images or motion pictures for AV equipment, information about used power, a failure or the like for home electric appliances, information about sales, maintenance or the like for outdoor equipment. etc.) on the offline device 1, a storage section 9 which stores information produced by the information producing section 8, and a display section 10 which displays the conditions of the offline device 1, the states of communications or the like with the information transferring device 2.

The information transferring device 2 comprises a control section 11 which is a CPU for supervising the control of the entire information transferring device 2, an interface 12 for connection with the external connection section 6 of the offline device, a storage section 13, a display section 14 which displays the conditions of the information transferring device 2 or the conditions of communications with the offline device 1, and a history erase button 15. The storage section 13 stores the information received from the offline device 1 and operational procedure information on the communication terminal 3 for starting communications by the communication terminal 3 with the center device 4 when the information transferring device 2 and the communication terminal 3 are connected.

In FIG. 2, an example structure of transmitting information with the external connection section 6 of the offline device and the interface 12 physically connected. But, radio communications by infrared rays or the like may be employed for transmission of information. And, means for transmitting information is not limited to a particular one.

The display section 10 of the offline device and the display section 14 of the information transferring device can also be configured to display the conditions by LED or the like.

The functions of the history erase button 15 of the information transferring device 2 will be described in detail later.

Here, when the information stored in the storage section 9 of the offline device is stored in the storage section 13 of the information transferring device, the operation is performed as follows. When the external connection section 6 of the offline device and the interface 12 are connected, the information transferring device 2 actively obtains information stored in the storage section 9 of the offline device via the interface 12 and stores it in the storage section 13 of the information transferring device. When the transmission of the information from the offline device 1 to the information transferring device 2 is completed, the user releases the connection between the external connection section 6 of the offline device and the interface 12.

The information stored in the storage section 13 of the information transferring device is stored into the storage section 9 of the offline device as follows. The external connection section 6 of the offline device and the interface 12 are connected, the information transferring device 2 transfers actively the information stored in the storage section 13 of the information transferring device to the offline device 1 via the interface 12, and the offline device 1 stores the transferred information in the storage section 9 of the offline device. When the transmission of the information from the information transferring device 2 to the offline device 1 is completed, the user releases the connection between the external connection section 6 of the offline device and the interface 12.

Then, the operation performed with the information transferring device 2 and the communication terminal 3 connected will be described.

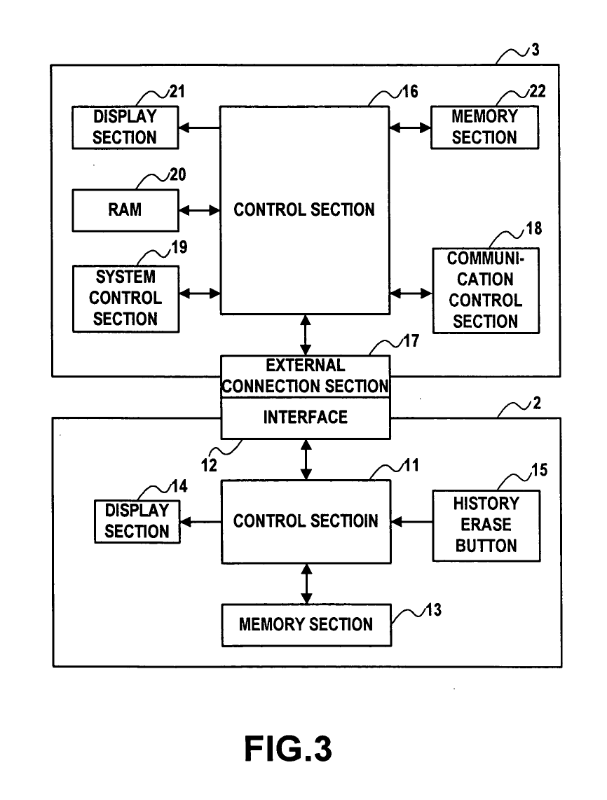

FIG. 3 is a block view showing an example of the outline structure of the information transferring device 2 and the communication terminal 3.

Here, the information transferring device 2 comprises the control section 11, the interface 12 for connection with an external connection section 17 of the communication terminal, the storage section 13, the display section 14, and the history erase button 15.

The communication terminal 3 comprises a control section 16 which is a CPU for supervising the control of the entire communication terminal 2, the external connection section 17 for connection with the interface 12 of the information transferring device 2, a communication control section 18 which sends and receives information to and from the center device 4 through a communication line or the like, a system control section 19 which is a ROM in which a control program for controlling the entire communication terminal 3 is stored, a RAM (Random Access Memory) 20 in which a work area or the like used for the control program is allocated, a display section 21 which displays states of communications with the information transferring device 2, states of communications with the center device 4 or the information received from the information transferring device 2, and a storage section 22 which stores a history of communications with the center device 4.

FIG. 3 shows an example structure of transmitting information with the external connection section 17 of the communication terminal and the interface 12 physically connected, but radio communications by infrared rays or the like may be employed for transmission of information. Thus, means for transmission of information is not limited to a particular one.

When the user connects the interface 12 and the external connection section 17 of the communication terminal as shown in FIG. 3, the control section 11 of the information transferring device automatically reads the operational procedure information which is stored in the storage section 13 and controls according to the read operational procedure information the control section 16 of the communication terminal via the interface 12, so that the communication control section 18 accesses the center device 4 (not shown) to start communication between the communication terminal 3 and the center device 4.

Here, the information which is stored in the storage section 13 of the information transferring device is transmitted to the center device 4 as follows. When communication between the communication terminal 3 and the center device 4 is started, the information transferring device 2 transmits the information stored in the storage section 13 of the information transferring device to the center device 4 via the communication control section 18 of the communication terminal 3, and the communication terminal 3 stores a history of communications with the center device 4 into the storage section 22 of the communication terminal. And, when the transmission of information from the communication terminal 3 to the center device 4 is completed, the user releases the connection between the interface 12 and the external connection section 17 of the communication terminal.

And, the communication terminal 3 receives information from the center device 4 as follows. When communication between the communication terminal 3 and the center device 4 is started, the communication terminal 3 receives the information transmitted from the center device 4 by the communication control section 18 and stores the received information into the storage section 13 of the information transferring device and a history of communications with the center device 4 into the storage section 22 of the communication terminal. And, when the transmission of the information from the center device 4 to the communication terminal 3 is completed, the user releases the connection between the interface 12 and the external connection section 17 of the communication terminal.

If the user desires to delete the history of communications with the center device 4 stored in the storage section 22 of the communication terminal when the transmission of the information from the communication terminal 3 to the center device 4 is completed, the history erase button 15 is operated. Then, the control section 11 of the information transferring device transmits an instruction of erasing the history of communications conducted when the information transferring device 2 and the communication terminal 3 are connected and stored in the storage section 22 of the communication terminal to the control section 22 of the communication terminal. Upon receiving the instruction of erasing the history, the control section 16 of the communication terminal erases the history of communications conducted when the information transferring device 2 and the communication terminal 3 are connected from the storage section 22 of the communication terminal.

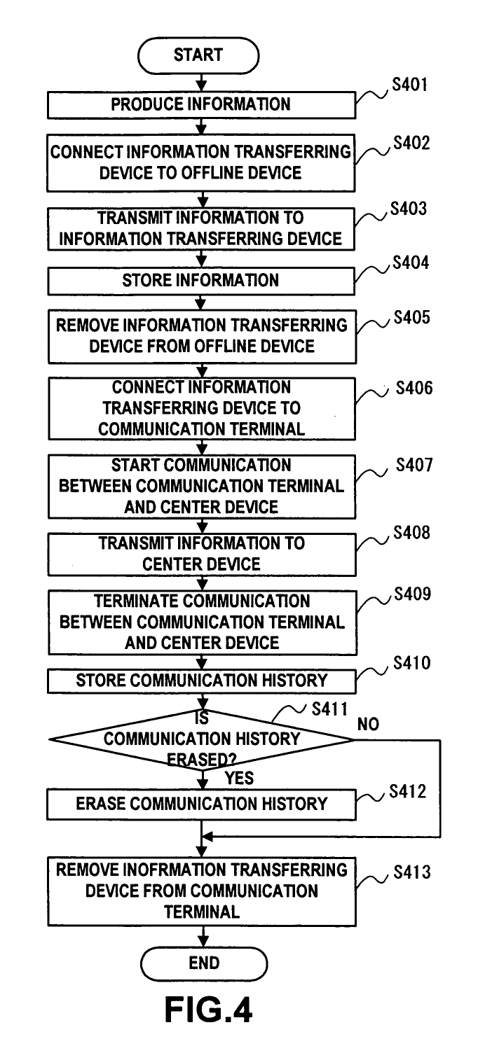

Then, a procedure of transferring the information of the offline device 1 of the information transfer system according to the present invention to the center device 4 will be described with reference to the flow chart of FIG. 4.

The offline device generates information (step S401), the information transferring device is connected to the offline device (step S402), the offline device transmits the information to the information transferring device (step S403), the information transferring device stores the received information (step S404), and the information transferring device is removed from the offline device (step S405).

When the information transferring device is connected to the communication terminal (step S406), the information transferring device starts communication between the communication terminal and the center device (step S407), the communication terminal transmits the information stored in the information transferring device to the center device (step S408), the communication terminal terminates the communications with the center device (step S409), and the communication terminal stores a history of communications with the center device (step S410).

When the history erase button is operated to instruct the erase of the communication history (YES in step S411), the communication history is erased (step S412), the information transferring device is removed from the communication terminal (step S413), and the processing procedure is terminated.

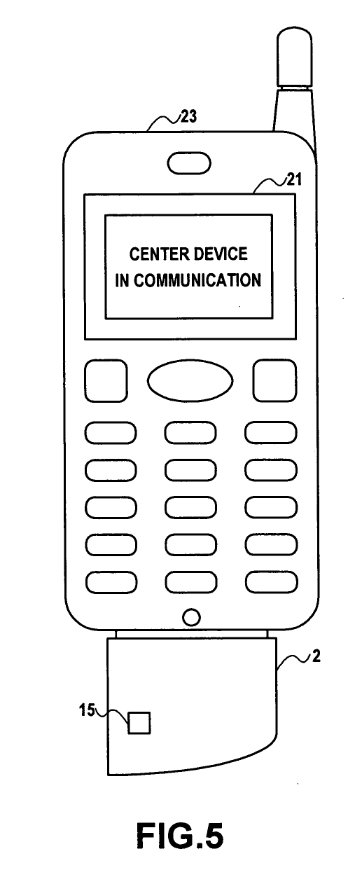

FIG. 5 is a view showing a state that the information transferring device 2 is connected to a cellular phone 23 or the like as the communication terminal 3.

As shown in FIG. 5, when the information transferring device 2 is connected to the external connection section of the cellular phone 23 or the like, communication between the cellular phone 23 or the like and the center device 4 is started, the information stored in the information transferring device 2 is transmitted to the center device 4. At this time, a message “Center device under communication” is displayed on the display section 21 of the cellular phone 23 or the like. It is also possible to configure so that the LED as the display section 14 of the information transferring device is blinked during communications, and the LED illuminates or goes off when the communication is terminated.

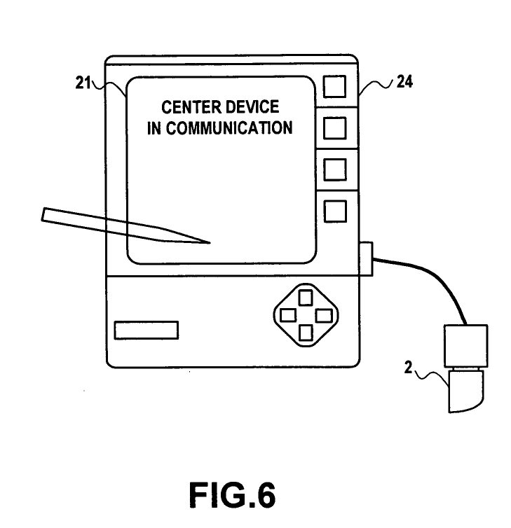

FIG. 6 is a view showing a state that the information transferring device 2 is connected to PDA 24 or the like as the communication terminal 3.

As shown in FIG. 6, when the information transferring device 2 is connected to an external connecter which is connected to the external connection section of the PDA 24 or the like, communication between the communication terminal 3 and the center device 4 is started, and the information stored in the information transferring device 2 is transmitted to the center device 4. At this time, a message “Center device under communication” is displayed on the display section 21 of the PDA 24 or the like.

Therefore, when the information transferring device 2 is connected to an online device such as the cellular phone 23, the PDA 24 or the like, the information stored in the information transferring device 2 is automatically transmitted to a management terminal such as the designated center device 4 or the like, so that the information can be transferred without fail.

### INDUSTRIAL APPLICABILITY

The present invention can provide an information transferring method and device which enables to transfer the information possessed by the offline device to the center device by a simple operation without fail or enables to transfer the information of the center device to the offline device by a simple operation without fail.

1. An information transferring method for transferring information possessed by an offline device to a center device by an information transferring device which is detachably connectable to the offline device and a communication terminal, comprising:
connecting the information transferring device to the offline device to store the information into an internal memory of the information transferring device;
after storing the information, connecting the information transferring device to the communication terminal; and
controlling the communication terminal by the information transferring device in a state connected to the communication terminal to automatically transfer the information stored in the internal memory of the information transferring device to the center device.

2. The information transferring method according to claim 1, wherein the information transferring device:
stores operational procedure information for transfer of the information to the center device by the communication terminal; and
controls the communication terminal according to the stored operational procedure information to control automatic transfer of the information stored in the internal memory of the information transferring device to the center device.

3. The information transferring method according to claim 1, wherein the information transferring device:
stores actively the information into the internal memory of the information transferring device when connected to the offline device; and
automatically transfers the information to the center device by actively controlling the communication terminal when connected to the communication terminal.

4. An information transferring method for transferring information possessed by a center device to an offline device by an information transferring device which is detachably connectable to the offline device and a communication terminal, comprising:
connecting the information transferring device to the communication terminal;
controlling the communication terminal by the information transferring device in a state connected to the communication terminal to automatically obtain the information possessed by the center device;
storing the automatically obtained information into an internal memory of the information transferring device;
after storing the information, connecting the information transferring device to the offline device; and
transferring the information stored in the internal memory of the information transferring device to the offline device by the information transferring device.

5. The information transferring method according to claim 4, wherein the information transferring device:
stores operational procedure information for obtaining information from the center device by the communication terminal; and
controls the communication terminal according to the stored operational procedure information to control the automatic acquisition of the information from the center device.

6. The information transferring method according to claim 4, wherein the information transferring device:
actively controls the communication terminal when connected to the communication terminal to automatically obtain the information from the center device and stores the automatically obtained information into the internal memory of the information transferring device; and
actively transfers the information stored in the internal memory of the information transferring device to the offline device when connected to the offline device.

7. An information transferring device which is configured to be detachably connectable to an offline device and a communication terminal and exchanges information via the communication terminal, comprising:
an internal memory for storing information possessed by the offline device when connected to the offline device; and
automatic communication control means for automatic transfer of the information stored in the internal memory to the center device by controlling the communication terminal when connected to the communication terminal.

8. The information transferring device according to claim 7, wherein the automatic communication control means:
controls the communication terminal when connected to the communication terminal to automatically obtain the information possessed by the center device;
stores the automatically obtained information into the internal memory of the information transferring device; and
transfers the information obtained by the automatic communication control means to the offline device when the information transferring device and the offline device are connected.

9. The information transferring device according to claim 8, wherein the automatic communication control means comprises:
storage means for storing first operational procedure information for transferring information to the center device by the communication terminal and second operational procedure information for obtaining information from the center device by the communication terminal;
first control means for controlling the automatic transfer of the information stored in the internal memory of the information transferring device to the center device by controlling the communication terminal according to the first operational procedure information stored in the storage means; and
second control means for controlling the automatic acquisition of the information possessed by the center device by controlling the communication terminal according to the second operational procedure information stored in the storage means.

10. The information transferring device according to claim 7, further comprising communication history erase instruction transmission means for transmitting an instruction of erasing a communication history of the automatic transfer and the automatic acquisition by the automatic communication control means to the communication terminal.

11. The information transferring device according to claim 7, further comprising display means for displaying a communication state of the automatic transfer or the automatic acquisition by the automatic communication control means.
